(19) United States
(12) Patent Application Publication
(10) Pub. No.: US 2006/0236747 A1
(43) Pub. Date: Oct. 26, 2006

(54) Sonic activation of strain sensitive cells

(75) Inventors: James E. Greenleaf, Rochester, MN (US); Mark E. Bolander, Rochester, MN (US); Heather M. Argadine, Rochester, MN (US); Randall R. Kinnick, Rochester, MN (US)

Correspondence Address: QUARLES & BRADY LLP, 411 E. WISCONSIN AVENUE, SUITE 2040, MILWAUKEE, WI, 53202-4497, US

(73) Assignee: Mayo Foundation For Medical Education and Research

(21) Appl. No.: 11/352,875

(22) Filed: Feb. 13, 2006

Related U.S. Application Data
(60) Provisional application No. 60/669,116, filed on Apr. 7, 2005.

(51) Int. Cl. G01V 13/00

(52) U.S. Cl. 73/1.82

(57) ABSTRACT

A method and apparatus for stimulating the growth of chondrocytes as part of a bone healing process includes a loudspeaker that applies audio frequency acoustic energy to the cells. A 1 kHz square wave at a 20 percent duty cycle is used and it is applied for a period of 20 minutes on each of a series of consecutive day.

### CROSS-REFERENCE TO RELATED APPLICATIONS

This application claims the benefit of U.S. Provisional patent application Ser. No. 60/669,116 filed on Apr. 7, 2005 and entitled “Sonic Activation Of Strain Sensitive Cells”.

### BACKGROUND OF THE INVENTION

The invention generally relates to the field of stimulating tissue growth and healing, and more particularly to apparatus and methods for stimulating chondrocytes that lead to accelerated healing of bone fractures.

When tissues in a human body such as connective tissues, ligaments, bones, etc. are damaged they require time to heal. Some tissues, such as a bone fracture in a human body, require relatively longer periods of time to heal. The healing process for a bone fracture in the human body may take several weeks and may vary depending upon the location of the bone fracture, the age of the patient, the overall general health of the patient, and other factors that are patient-dependent. Depending upon the location of the fracture, the area of the bone fracture, the patient may have to be immobilized to encourage complete healing of the bone fracture. Immobilization of the patient for extended periods of time may have other adverse health consequences.

Promoting bone growth is important in treating bone fractures, and it is important in the successful implantation of medical prostheses, such as those commonly known as “artificial” hips, knees, vertebral discs, and the like, where it is desired to promote bony ingrowth into the surface of the prosthesis to stabilize and secure it. Numerous techniques have been developed to promote healing of bone fractures. For example, it has been proposed to treat bone fractures by application of electrical voltage or current signals (e.g., U.S. Pat. Nos. 4,105,017; 4,266,532; 4,266,533, or 4,315,503). It has also been proposed to apply magnetic fields to stimulate healing of bone fractures (e.g., U.S. Pat. No. 3,890,953). Application of ultrasound to promoting tissue growth has also been disclosed (e.g., U.S. Pat. No. 4,530,360).

It has been shown that a 1.5 MHz ultrasound signal, consisting of a 200 μs tone burst repeating at 1 kHz intervals, can stimulate chondrocytes and lead to accelerated bone fracture healing. Double-blind placebo-controlled clinical studies have shown that such pulsed ultrasound exposure is able to shorten the time to normal bone strength in both radius and tibial fractures. In vitro, such ultrasound exposure increased aggrecan mRNA and proteoglycan synthesis in chondrocytes. In animal studies, the same ultrasound exposure invariably increased mRNA expression from fracture callus. In addition, histological analysis of the fracture callus showed increased cartilage area. These findings suggest that pulsed ultrasound may have an effect on chondrocytes and may be able to modulate chondrogenesis and, following bone formation, these effects may eventually develop bone union at the fracture gap.

An ultrasonic device is available that exploits this treatment method. This device uses a 1.5 MHz ultrasound carrier signal having a 200 μs tone burst repeating at 1 kHz intervals for treating fractures 20 minutes per day. This is an in vitro device which consists of a frame holding 6 transducers, one under each well of a 6-well plate. Ultrasound gel is placed between the transducers and the plate. This device has demonstrated increased proteoglycan synthesis in chondrocytes. A disadvantage, of the ultrasound treatment method, however, is the effect of heating. It has been found that after 20 minutes of treatment with the device, there is a 2-3° C. rise in temperature of the media.

### SUMMARY OF THE INVENTION

The present invention is a method and apparatus for stimulating the growth of chondrocytes as part of the bone healing process. More specifically, it has been discovered that growth of chondrocytes is stimulated by the periodic treatment with 1 kHz sound waves with no resulting increase in temperature. Preferably, the waveform of the applied sound waves is not sinusoidal such that higher frequency harmonics are also produced and applied during treatment.

A general object of the invention is to provide a method and an in vitro apparatus that stimulates chondrocytes and causes them to produce extracellular matrix which leads to accelerated bone fracture healing. By administering a treatment with 1 kHz sound each day for a number of days, a highly significant increase in chondrogenesis occurs.

Another object of the invention is to stimulate bone fracture healing without generating heat and with an inexpensive apparatus. The apparatus needed to practice the present method is little more than a loudspeaker driven by a 1 kHz signal source. The resulting audio frequency pressure waves produced in the treated bone do not produce any significant heating.

### BRIEF DESCRIPTION OF THE DRAWINGS

FIG. 1 is a top view of the treatment tray used in the preferred embodiment of the invention;

FIG. 2 is a view in cross-section taken along the plane 2-2 indicated in FIG. 1

FIG. 3 is a circuit diagram of speakers used in the treatment tray of FIG. 1;

FIG. 4 is a graph indicating the results of treatment using the present invention in terms of number of nodules grown; and

FIG. 5 is a graph indicating the results of treatment using the present invention in terms of nodule size.

### DETAILED DESCRIPTION OF THE PREFERRED EMBODIMENT

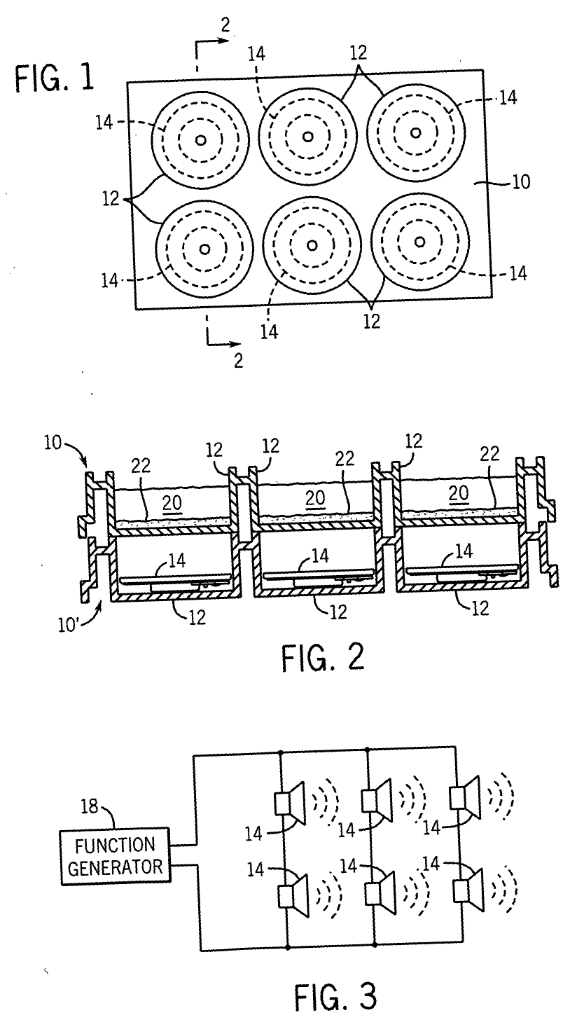

Referring particularly to FIG. 1, the treatment tray is formed around a molded plastic, 6-well cell culture plate 10. The culture plate 10 includes six circular recesses, or wells 12 in its top surface. The dimensions of the 6-well plate 10 are 12.8 cm×8.6 cm×2 cm. Each well 12 has a surface area of 9.6 cm². As shown best in FIG. 2, a maintenance medium 20 is disposed in each of the wells 12 and the cells to be treated 22 are disposed on the bottom of each well 12.

The cell culture plate 10 is stacked on top of an identical plate 10′ with the six wells 12 in the culture plate 10 aligned directly above corresponding wells 12 in the lower plate 10′. Six loudspeakers 14 are mounted in the respective six wells 12 of the lower plate 10. The speakers 14 face upward and are bonded to the bottom surface of each well 12. An enclosed air space is formed between each speaker 14 and the bottom wall of the well 12 directly above it. As a result, the acoustic energy produced by the loudspeakers 14 is efficiently coupled to the well bottom walls and the cells 22 which they support. The stacked cell plates 10 and 10′ enable the cells 22 and medium 20 to be easily removed and then reinstalled in the exact same alignment with the loudspeakers 14. The speakers 14 are commercially available from Panasonic as the model EAS2P104H. The active surface area of each speaker is 6.2 cm².

As shown in FIG. 3, the speakers 14 are connected in series-parallel and driven by a function generator 18. The speakers 14 are driven with a 1 kHz square wave at 18 mV peak to peak with a 20% duty cycle. A scanning laser vibrometer was used to examine the motion produced by each speaker 14, and the bottom of each well 12 was found to move an average of 1 nm with a drum-like motion, where the center of the well 12 moves more than the periphery. For the 1 kHz apparatus, the voltage used to drive the speakers was adjusted to give an average displacement of 2 nm. A square wave was used because the harmonics it produces enhances a drum-like motion of each well bottom.

As shown in FIG. 2, the cells to be treated 22 are plated in the wells 12 such that they are disposed directly above one of the speakers 14. ATDC5 cells, a chondrogenic clonal cell line, were cultured in a maintenance medium 20 consisting of a mixture of Dulbecco's modified Eagle medium and Ham's F-12 medium, supplemented with 5% fetal bovine serum, 1% penicillin-streptomycin, 10 μg/ml human transferrin, and 3×10⁻⁸ M sodium selenite. ATDC5 cells are chondrocyte precursors, which can be differentiated into chondrocytes with the addition of insulin. ATDC5 cells that do not receive insulin remain chondrocyte precursors. Cells were maintained at 37° C. in a humidified atmosphere of 5% CO₂ in air. The cells were allowed to remain in culture for three days before sonic treatments.

Starting the third day after plating the cells 22, sound treatments were administered for 20 minutes each day for 11 days. Variations of this regimen are possible (i.e., starting treatments 5 or 7 days after plating and treating for 7 or 9 days, etc.), but this regimen is preferred. The treatments were performed in a 37° C. incubator. Each well 12 of the six-well plate 10 had 3 ml media and the media was changed every other day during the treatment process.

Several treatment regimens have been tried, but the regimen of 3 days plated and 11 days of ultrasound treatments gave the best response to 1 kHz acoustic energy. There were 6 treatment plates in this experiment. Each treatment plate received 1 kHz squarewave, 20% duty cycle for 20 minutes per day. The treatments were performed in a 37° C. incubator. Treatment regimen varied for each plate, in order to determine the effect of start time of treatments and the number of treatments received. The treatment regimens were as follows:
14 days total in culture: 8 days plated, then 6 days of 1 kHz treatments
17 days total in culture: 5 days plated, then 12 days of 1 kHz treatments 8 days plated, then 9 days of 1 kHz treatments 11 days plated, then 6 days of 1 kHz treatments
20 days total in culture: 8 days plated, then 12 days of 1 kHz treatments.

Each plate was observed under the microscope every day over the course of the experiment. During the process of chondrogenesis, chondrocytes produce extracellular matrix proteins, including proteoglycan and collagen II. These proteins condense to form nodules. The earliest day that nodules of cartilage were observed in the control plates was the sixteenth day after plating. On the other hand, all of the treated plates except for one (5 days plated, 12 days of treatments) had nodules visible on the eleventh day. This suggests treatment with 1 kHz vibration accelerated the date of visible formation of cartilage nodules. We found similar results in quantitative optical spectrometry. In previous experiments, Wang, S-J., D. G. Lewallen, M. E. Bolander, E. Y. S. Chao, and J. F. Greenleaf: Low Intensity Ultrasound Treatment Increases Strength In A Rat Femur Fracture Model, Journal of Orthopaedic Research 12(1):4047, 1994; Yang, K-H., J. Parvizi, S-Y. Wang, D. G. Lewallen, R. R. Kinnick, J. F. Greenleaf, and M. E. Bolander: Exposure To Low-Intensity Ultrasound Increases Aggrecan Gene Expression In A Rat Femur Fracture Model, Journal of Orthopaedic Research 14(5):802-809, 1996; and Parvizi, J., C-C. Wu, D. G. Lewallen, J. F. Greenleaf, and M. E. Bolander: Low Intensity Ultrasound Stimulates Proteoglycan Synthesis In Rat Chondrocytes By Increasing Aggrecan Gene Expression, Journal of Orthopaedic Research 17(4):488-494, 1999, the acceleration of aggrecan production or collagen production as we see with the 1 kHz treatment was associated with accelerated bone fracture healing.

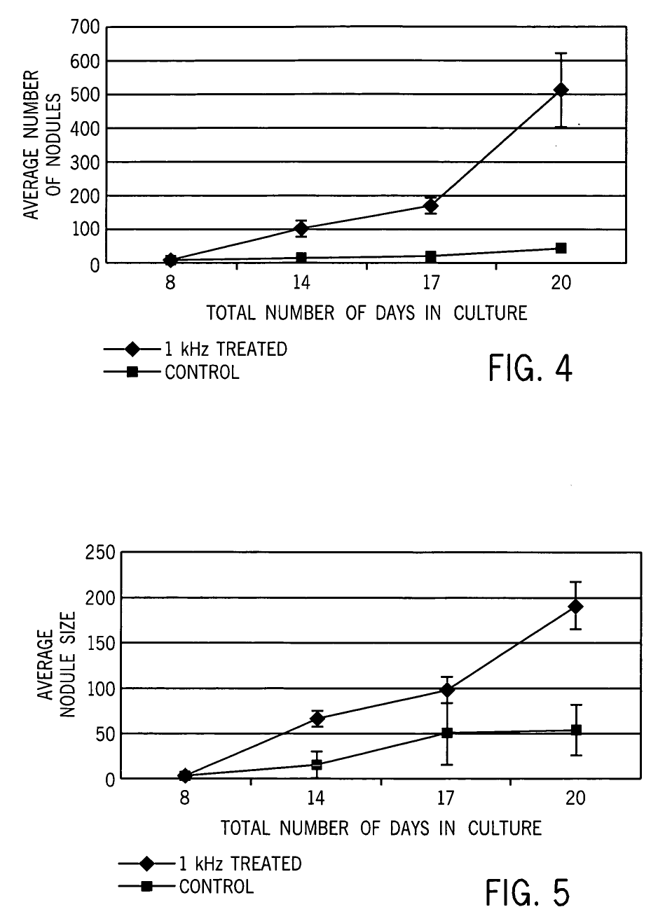

The treatment regimen strongly affected the number and size of nodules. Referring to FIGS. 4 and 5, when treatments were begun on the same day, more treatments led to an increased number and size of nodules. Average nodule size refers to the average number of pixels for one nodule. A larger number of nodules corresponds to a larger number of differentiation events, indicating that 1 kHz vibration increased differentiation of ATDC5 clonal chondrogenic cells. A larger area of nodules corresponds to increased proliferation, indicating that 1 kHz vibration not only increases differentiation but also proliferation of ATDC5 cells.

Results show that 1 kHz vibration induces chondrogenesis as much as 1.5 MHz pulsed ultrasound in ATDC5 clonal chondrogenic cells, but without the generation of heat and resulting temperature increase. Experiments focusing on 1 kHz treatments show that 1 kHz vibration not only increases chondrogenesis but also increases differentiation and proliferation of ATDC5 cells.

1. A method for promoting chondrogenesis of in vitro chondrocyte cells which includes:
a) exposing the chondrocyte cells to acoustic energy at an audio frequency for a period of time; and
b) repeating the exposure of step a) during each of a plurality of days.

2. The method as recited in claim 1 in which the audio frequency is substantially 1 KHz.

3. The method as recited in claim 2 in which the waveform of the acoustic energy contains harmonics of 1 kHz.

4. The method as recited in claim 3 in which the audio frequency waveform has a 20% duty cycle.

5. The method as recited in claim 3 in which the waveform is substantially a square wave.

6. The method as recited in claim 1 in which the acoustic energy is produced by an audio transducer driven by a 1 kHz square wave signal having a 20% duty cycle.

7. A device for promoting chondrogenesis in chondrocyte cells which comprises:
a container for holding the chondrocyte cells;
an acoustic transducer disposed beneath the container for directing acoustic energy into the container;
a signal generator connected to the acoustic transducer and operable to drive the acoustic transducer with an audio frequency signal.

8. The device as recited in claim 6 in which the acoustic device is a loudspeaker.

9. A method for promoting chondrogenesis in chondrocyte cells which includes exposing the chondrocyte cells to acoustic energy produced by an audio frequency square wave.

10. The method as recited in claim 9 in which the audio frequency square wave is substantially 1 KHz.

11. The method as recited in claim 10 in which the audio frequency square wave has a 20% duty cycle.

12. A device for promoting chondrogenesis in chondrocyte cells which comprises:
a container for holding the chondrocyte cells;
an acoustic transducer disposed beneath the container for directing acoustic energy into the container;
a signal generator connected to the acoustic transducer and operable to drive the acoustic transducer with an audio frequency signal having a substantially square wave shape.
